(19) United States
(12) Patent Application Publication
(10) Pub. No.: US 2026/0230606 A1
(43) Pub. Date: Aug. 6, 2026

(54) SYSTEMS AND METHODS FOR INDICATING INTRA TEMPLATE MATCHING PREDICTION

(71) Applicant: GUANGDONG OPPO MOBILE TELECOMMUNICATIONS CORP., LTD., Dongguan (CN)

(72) Inventors: Yue YU, Palo Alto, CA (US); Jonathan GAN, Palo Alto, CA (US); Haoping YU, Palo Alto, CA (US)

(21) Appl. No.: 19/149,951

(22) PCT Filed: Jan. 26, 2024
(86) PCT No.: PCT/US2024/013246

§ 371 Date: Jul. 22, 2025

Related U.S. Application Data
(60) Provisional application No. 63/441,750, filed on Jan. 27, 2023.

(51) Int. Cl. H04N 19/11; H04N 19/167; H04N 19/176; H04N 19/44; H04N 19/593; H04N 19/70

(52) U.S. Cl. CPC H04N 19/11; H04N 19/167; H04N 19/176; H04N 19/593; H04N 19/70; H04N 19/44

(57) ABSTRACT

Methods and systems for video processing are provided. In some embodiments, the method includes (i) determining if a current block is in an IntraTMP mode; (ii) parsing and identifying an IntraTMP flag in response to a determination that the current block is in the IntraTMP mode. If the current block is in the IntraTMP mode, the method includes: parsing and identifying an IntraTMP fusion flag in response to a determination that the current block is in the IntraTMP fusion mode. If the current block is in the IntraTMP fusion mode, the method includes: generating a fused IntraTMP predictor in response to a determination that the current block is configured to use the IntraTMP fusion method.

### TECHNICAL FIELD

The present disclosure relates to imaging and video coding technologies. More particularly, video coding schemes including intra template matching prediction (IntraTMP) methods are disclosed herein.

### BACKGROUND

Existing video compression methods, such as High Efficiency Video Coding (HEVC) and Versatile Video Coding (VVC) perform blocking and quantization processes when coding. The HEVC and VVC standards specify a block-based, hybrid spatial and temporal predictive coding scheme. During coding, each picture is first divided into square blocks called CTUs (Coding Tree Units). Each CTU in a picture can be partitioned into one or more Coding Units (CUs), which can be used for prediction and transform. A variety of prediction tools may be used, including inter-prediction and intra-prediction tools. Inter-prediction tools may use any information from pictures that have been previously coded to a bitstream. On the other hand, intra-prediction tools may only use reconstructed samples from the same picture. Therefore, it is important to effectively determine which reconstructed samples are to be used. Therefore, it is advantageous to have an improved system and method to address the foregoing needs.

### SUMMARY

The present disclosure is related to systems and methods for improving image qualities of videos by using an improved intra template matching prediction (IntraTMP) method. The present disclosure is also related to systems and methods for indicating IntraTMP methods. Intra template matching prediction predicts its current coding unit (CU) by a block of samples from a current picture. In some embodiments, the IntraTMP is selected as a prediction mode for CUs with a size “64×64” or smaller.

The present systems provides various syntax formats/configurations for indicating and/or signaling whether IntraTMP and other suitable methods are used. Embodiments regarding the foregoing syntax formats/configurations are discussed in detail with reference to FIGS. 2C-2E.

During a coding process, a coding device (e.g., an encoder or a decoder) compares a pre-defined “L-shaped” or other shaped template of reconstructed samples neighboring the current CU against the same shaped templates of candidate predictors within a pre-determined search region and determines an IntraTMP predictor block. In cases where the template is “L-shaped,” both neighboring samples to the left and above the current CU are used as the template for the current CU. Similarly, neighboring samples to the left and above of candidate predictors are used as the candidate template for each candidate predictor. The IntraTMP predictor block is determined by finding the best candidate template that matches the current CU template. Embodiments of an “L-shaped” template are discussed in detail with reference to FIG. 2A. In some embodiments, a different template shape can be used, in which case the different template shape is used as the candidate template for each candidate predictor.

The present system provides an improved method to determine the pre-determined search region. It is particularly beneficial for effectively search since certain conventional methods do not effectively search available reconstructed samples. The present system enables an IntraTMP process to search any regions in a current CTU (coding tree unit) that are available for intra prediction. More particularly, the present system enables searching in a “top-right” neighboring region and/or a “bottom-left” neighboring region of the current CU.

The “top-right” neighboring region and the “bottom-left” neighboring region are within the current CTU. The “top-right” neighboring region is adjacent to the current CU and extends from a “top-right” point of the current CU in a “top-right” direction. The “bottom-left” neighboring region is adjacent to the current CU and extends from a “bottom-left” point of the current CU in a “bottom-left” direction. In some embodiments, the “top-right” neighboring region and the “bottom-left” neighboring region are in the same shape with different orientations (e.g., the “top-right” neighboring region is in a vertical orientation, whereas the “bottom-left” neighboring region is in a horizontal orientation). Embodiments of an improved search region including the “top-right” and “bottom-left” neighboring regions are discussed in detail with reference to FIGS. 2B and 3-5C.

The present systems and methods enable including any CUs preceding the current CU in a current CTU in an IntraTMP search region. The IntraTMP search region can be scanned following a scan order. Embodiments of the scan order are discussed in detail with reference to FIG. 4A. Compared to the conventional methos, the present systems and methods enhance template searching by adding neighboring regions to a current CU (e.g., “bottom-left”and “top-right” region within the current CTU). With the enhanced searching area provided by the present systems, the IntraTMP process can be more effective and thus reducing processing time as well as providing a better coding result.

In some embodiments, the best candidate template can be determined by finding the template that minimizes the sum of absolute differences (SAD), or the sum of absolute transformed differences (SATD), or by comparing hashes between templates. In some embodiments, some search algorithms can be used. In some embodiments, the search algorithms through the pre-determined search region can be exhaustive (e.g., by scanning the template over the search region with sample-resolution shifts), or fast (e.g., by performing a coarse search first, then performing a local refinement search around the best match from the coarse search). The search algorithms can be performed identically by both an encoder and a decoder so that the IntraTMP predictor is implicitly known by both the encoder and decoder without requiring signaling in the bitstream.

Though the following systems and methods are described in relation to video processing, in some embodiments, the systems and methods may be used for other image processing systems and methods. The present disclosure also provides a framework/network that can be trained by deep learning and/or artificial intelligent schemes.

In some embodiments, the methods discussed herein for a “picture” or a “frame” can be applied to a portion or a region of the “picture” or the “frame.” For example, the methods disclosed herein can be applied to a sub-picture, a region of a picture (e.g., showing an object of interest), etc.

In some embodiments, the present method can be implemented by a tangible, non-transitory, computer-readable medium having processor instructions stored thereon that, when executed by one or more processors, cause the one or more processors to perform one or more aspects/features of the method described herein. In other embodiments, the present method can be implemented by a system comprising a computer processor and a non-transitory computer-readable storage medium storing instructions that when executed by the computer processor cause the computer processor to perform one or more actions of the method described herein.

### BRIEF DESCRIPTION OF THE DRAWINGS

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

FIG. 1A is a schematic diagram illustrating a system having an IntraTMP module in accordance with one or more implementations of the present disclosure.

FIG. 1B is a schematic diagram illustrating a decoding system having an IntraTMP module in accordance with one or more implementations of the present disclosure.

FIGS. 2A and 2B are schematic diagrams illustrating IntraTMP processes in accordance with one or more implementations of the present disclosure.

FIGS. 2C-2E are schematic diagrams illustrating syntax examples for an IntraTMP flag in accordance with one or more implementations of the present disclosure.

FIG. 3 is a schematic diagram illustrating an intra prediction process in accordance with one or more implementations of the present disclosure.

FIG. 4A is a schematic diagram illustrating a search sequence of an IntraTMP process in a search area in accordance with one or more implementations of the present disclosure.

FIG. 4B is a schematic diagram illustrating an example partitioning of a CTU into CUs in accordance with one or more implementations of the present disclosure.

FIG. 4C is a schematic diagram illustrating slice partitioning in accordance with one or more implementations of the present disclosure.

FIG. 4D is a schematic diagram illustrating tile partitioning in accordance with one or more implementations of the present disclosure.

FIG. 4E is a schematic diagram illustrating dividing a picture into wavefronts in accordance with one or more implementations of the present disclosure.

FIGS. 5A-5C are schematic diagrams illustrating search areas of IntraTMP processes in accordance with one or more implementations of the present disclosure.

FIG. 6 is a schematic diagram of a wireless communication system in accordance with one or more implementations of the present disclosure.

FIG. 7 is a schematic block diagram of a terminal device in accordance with one or more implementations of the present disclosure.

FIG. 8 is a schematic block diagram of an electronic device in accordance with one or more implementations of the present disclosure.

FIG. 9 is a flowchart of a method in accordance with one or more implementations of the present disclosure.

### DETAILED DESCRIPTION

To describe the technical solutions in the implementations of the present disclosure more clearly, the following briefly describes the accompanying drawings. The accompanying drawings show merely some aspects or implementations of the present disclosure, and a person of ordinary skill in the art may still derive other drawings from these accompanying drawings without creative efforts.

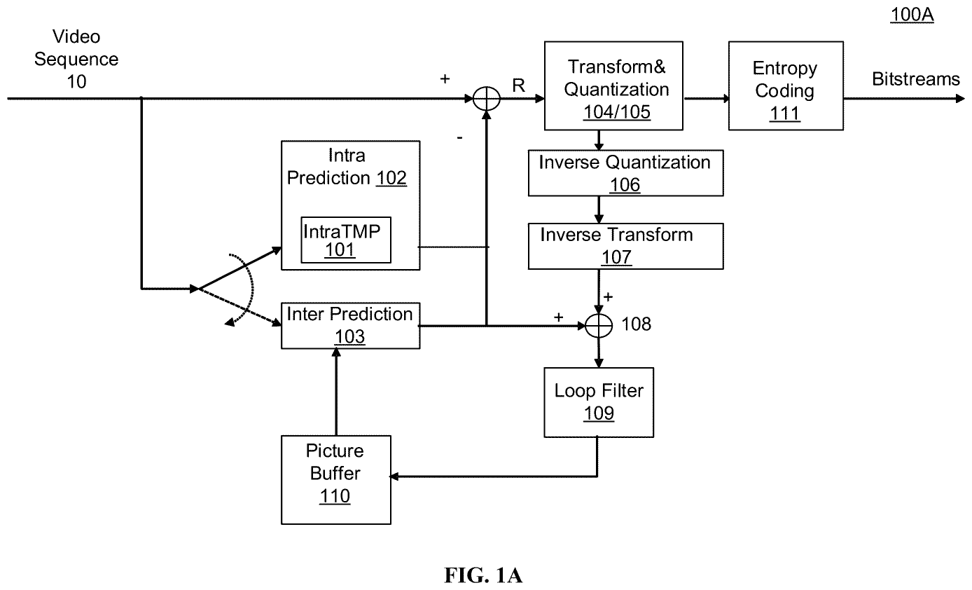

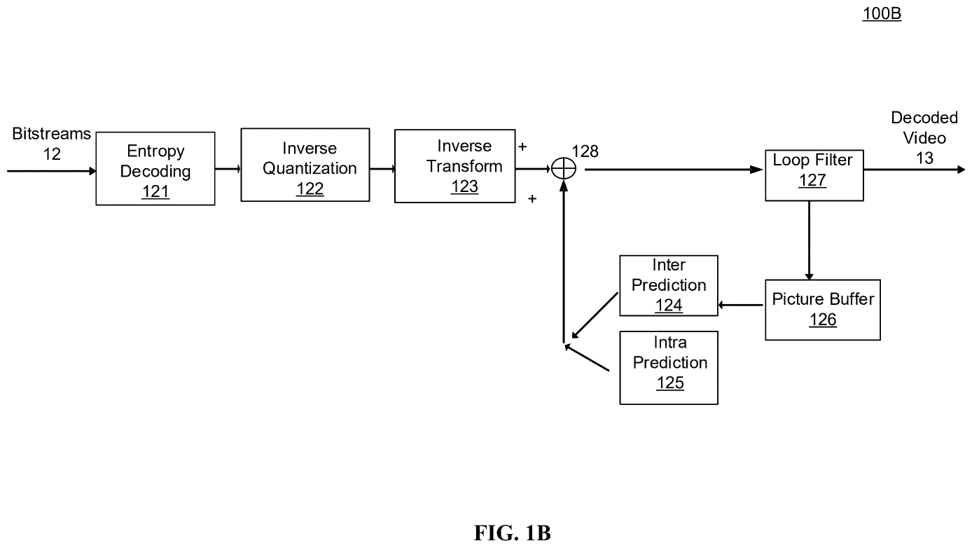

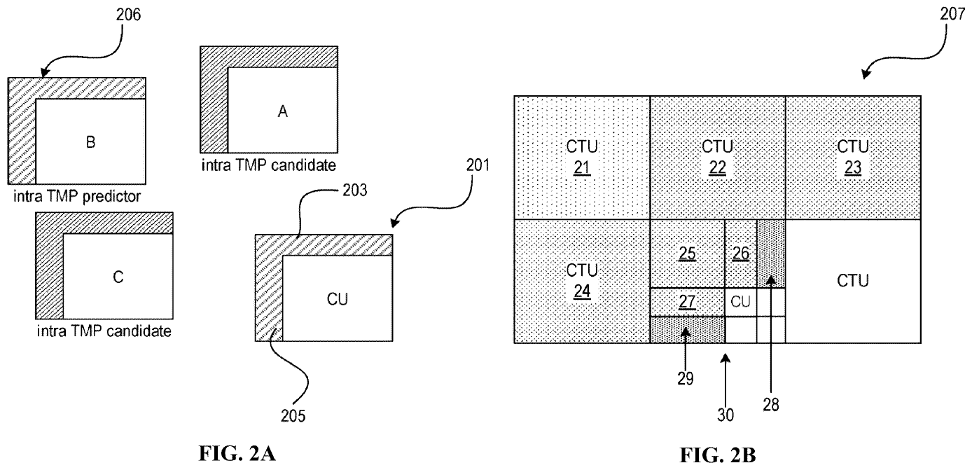

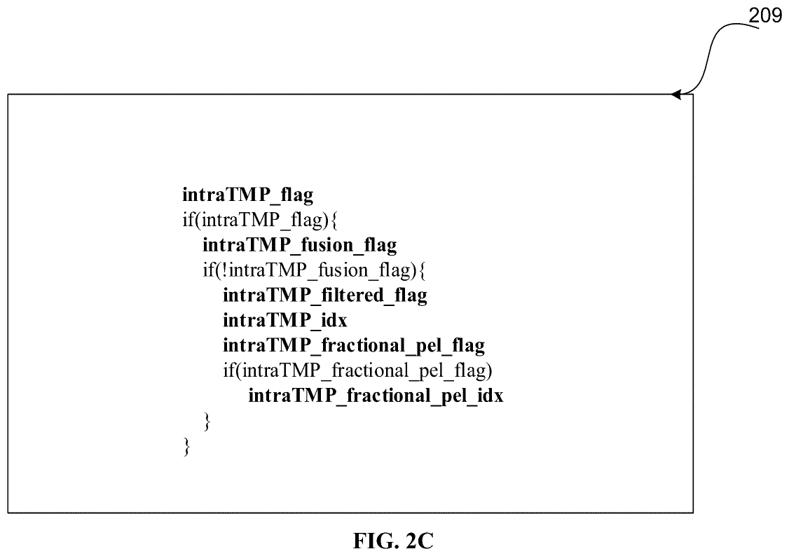

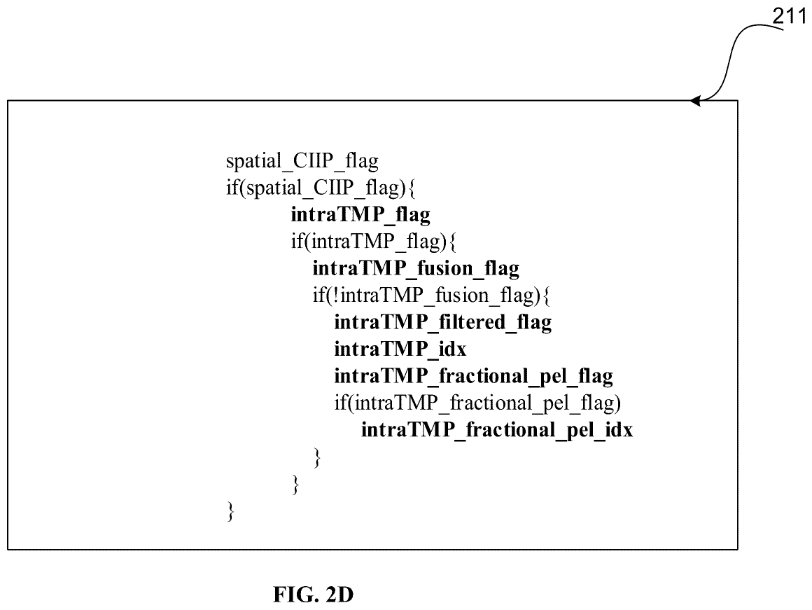

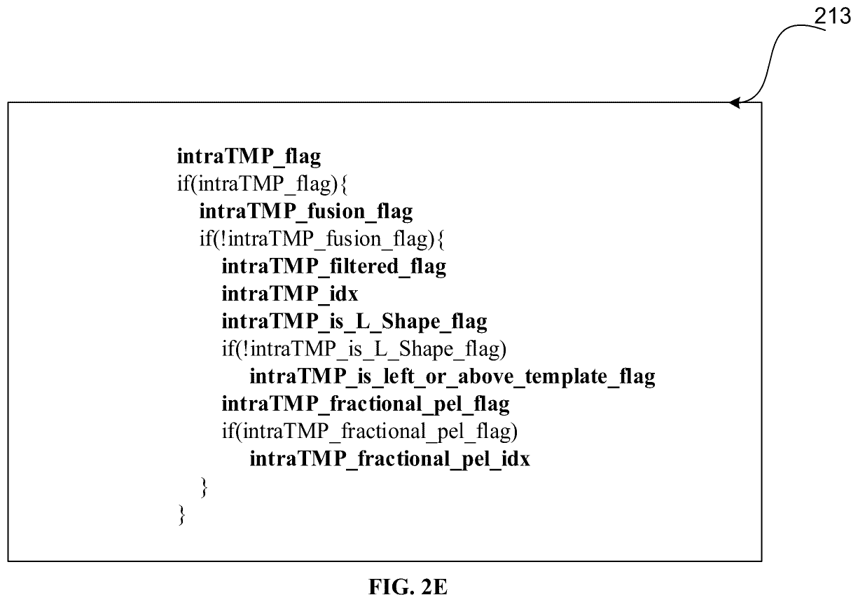

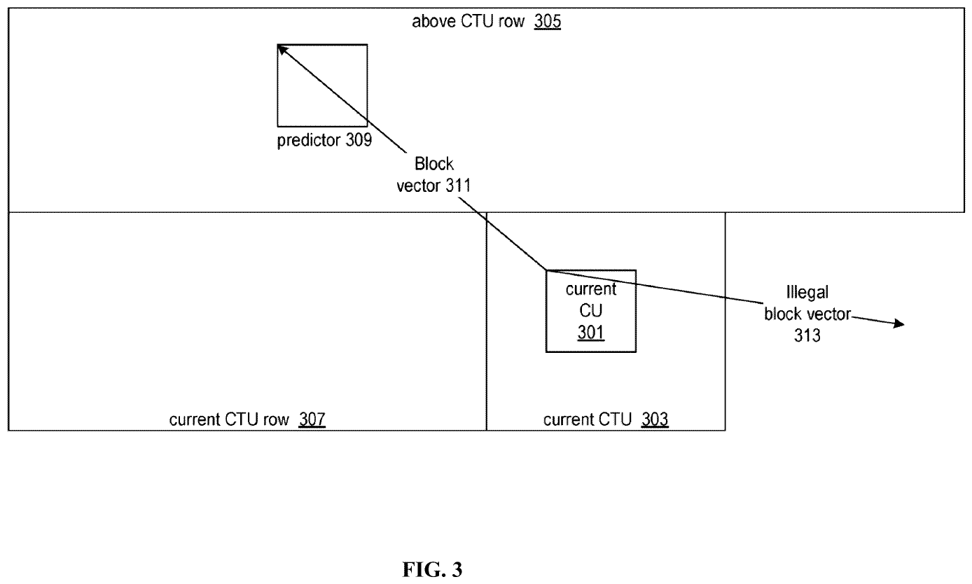

FIG. 1A is a schematic diagram illustrating a system 100A having an IntraTMP module 101 (in an intra prediction module 102) in accordance with one or more implementations of the present disclosure. The IntraTMP module 101 is configured to perform a template search process in an improved search area (e.g., FIG. 2B). In some embodiments, in addition to the IntraTMP module 101, the intra prediction module 102 can also include other intra-prediction modules/tools, such as IBC (Intra Block Copy), SGPM (Spatial Geometric Partitioning Mode), MIP (Matrix-based Intra Prediction), regular angular intra prediction tools, etc.

The system 100A includes a video sequence 10 as input to the intra prediction module 102 and/or an inter prediction module 103. The output of the intra prediction module 102 and/or the inter prediction module 103 can be subtracted from a current CU of the video sequence 10 to generate a residual R. Then the residual R can be directed to a transform module 104. The output of the transform module 104 can be quantized by a quantization module 105. The output of the quantization module 105 can then be directed to an inverse quantization module 106 and an inverse transform module 107.

As shown in FIG. 1A, at an adder 108, the output of the intra prediction module 102 and/or the inter prediction module 103 can be added with the output of the inverse transform module 107. The added result can then be directed to an in-loop filter 109. The output of the in-loop filter 109 can then be directed to a decoded picture buffer 110 for further processes by the inter prediction module 103. The system 100A uses loop filters to suppress compression artifacts and reduce distortion. These loop filters include a deblocking filter (DBF), a sample adaptive offset (SAO) filter, and an adaptive loop filter (ALF). In some embodiments, the in-loop filter 109 is not required to include all of the filters described above. In some embodiments, the DBF and the SAO filter are two filters designed to reduce artifacts caused by an encoding process. The DBF focuses on visual artifacts at block boundaries. The SAO filter complementarily reduces artifacts that may arise from quantization of transform coefficients within blocks. The ALF can enhance an adaptive filter of a reconstructed signal, reducing a mean square error (MSE) between the original and reconstructed samples by using a Wiener-based adaptive filter. The system 100A also includes an entropy coding module 111 configured to perform data compression before generating a bitstream 11.

FIG. 1B is a schematic diagram illustrating a decoding system 100B having an IntraTMP module (e.g., the IntraTMP module 101 discussed in FIG. 1A) in accordance with one or more implementations of the present disclosure. The system 100B includes an entropy decoding module 121, an inverse quantization module 122, and an inverse transform module 123 configured to process a bitstream 12. The decoding system 100B also includes an inter prediction module 124 and an intra prediction module 125 (e.g., corresponding to the intra prediction module 102 at the encoding side). The inter prediction module 124 and the intra prediction module 125 are configured to process the bitstream 12 and generate a decoded video 13. As shown in FIG. 1B, the decoding system 100B also includes a picture buffer 126 and a loop filter 127 to facilitate the foregoing decoding tasks.

As shown in FIG. 1B, at an adder 128, the output of the intra prediction module 125 and/or the inter prediction module 124 can be added with the output of the inverse transform module 123. The added result can then be directed to the loop filter 127 so as to generate the decoded video 13.

FIG. 2A is a schematic diagram illustrating a candidate predictor 201 for a coding unit (CU) for an IntraTMP process in accordance with one or more implementations of the present disclosure. As shown in FIG. 2A, the candidate predictor 201 includes a first region upper 203 to the CU and a second region 205 left to the CU. The first region 203 and the second region 205 form an “L-shape.” In some embodiments, the candidate predictor 201 can be in other shapes (e.g., including either one of the first region 203 and the second region 205). The candidate predictor 201 is configured to be used to search a matching candidate MC from multiple candidates (e.g., candidates A, B, and C as shown in FIG. 2B) in a search area (e.g., a current CTU, a reconstructed area, etc.). In the illustrated embodiments, candidate B is selected as the matching candidate BC. The IntraTMP process then uses the data (e.g., pixels) surround by the candidate predictor 201 as reference data for the CU.

In some embodiments, the best candidate template can be determined by finding the template that minimizes the sum of absolute differences (SAD), or the sum of absolute transformed differences (SATD), or by comparing hashes between templates. In some embodiments, some search algorithms can be used. In some embodiments, the search algorithms through the pre-determined search region can be exhaustive (e.g., by scanning the template over the search region with sample-resolution shifts), or fast (e.g., by performing a coarse search first, then performing a local refinement search around the best match from the coarse search). The search algorithms can be performed identically by both an encoder and a decoder so that the IntraTMP predictor is implicitly known by both the encoder and decoder without requiring signaling in the bitstream.

FIG. 2B is a schematic diagram illustrating a current IntraTMP search area 207 for an IntraTMP process in accordance with one or more implementations of the present disclosure. As shown in FIG. 2B, the search area 207 is for performing a candidate search (e.g., described above with reference to FIG. 2A) for a CU. The search area 207 includes multiple regions including CTU regions 21-24, sub-CTU regions 25-26, a “top-right” neighboring region 28, and a “bottom-left” neighboring region 29. The “top-right” neighboring region 28 is located at a top-right corner of the current CU within the same CTU 30 and has already been reconstructed. The “bottom-left” neighboring region 28 is located at a bottom-left corner of the current CU within the same CTU 30 and has already been reconstructed. By these arrangements, the present system enables an IntraTMP process to search candidates within an improved search area (i.e., the current IntraTMP search area 207), which is larger than conventional methods.

FIGS. 2C-2E are schematic diagrams illustrating syntax examples for an IntraTMP flag in accordance with one or more implementations of the present disclosure.

### Example 1

In FIG. 2C, syntax 209 provides an example showing how a flag for IntraTMP (“intraTMP_flag”) can be signaled. When a current block is an IntraTMP block (e.g., using an IntraTMP process), flag “intraTMP_flag” can be signaled first to indicate that the current block is using IntraTMP. Flag “intraTMP_fusion_flag” can be used to signal and indicate that the current block will use an IntraTMP fusion method to generate a prediction by fusing several IntraTMP matched blocks with weighting.

If the IntraTMP fusion method is used, a fused IntraTMP predictor can be generated. If the IntraTMP fusion method is not used, another flag “intraTMP_filtered_flag” can be signaled to indicate that whether a filtered IntraTMP prediction block will be used. In some embodiments, if the filtered IntraTMP method is used, the identified IntraTMP prediction block can be further filtered according to a derived filter. In addition, an index “intraTMP_idx” can be signaled to indicate which IntraTMP block will be used from an IntraTMP candidate list.

Furthermore, another flag “intraTMP_fractional pel flag” can be signaled to indicate if a fractional-pel precision prediction block (e.g., half-pel, quarter-pel, or other suitable precision) will be used. In an event that the fractional-pel precision is used, a fractional-pel index “intraTMP_fractional_pel_idx” can be signaled to indicate a fractional-pel position.

### Example 2

In FIG. 2D, syntax 211 provides an example showing how a flag for a combined inter-intra prediction (CIIP) (“spatial_CIIP_flag”) can be signaled. As shown, syntax 211 includes flag “spatial_CIIP_flag” to indicate that there is a special fusion of IntraTMP and other suitable inter/intra prediction methods. For example, in some embodiments, one IntraTMP matched block can be fused with another prediction derived by using DIMD (Decoder-side Intra Mode Derivation) methods, TIMD (Template-based Intra Mode Derivation), a planar mode and weight calculation method following suitable regulations (e.g., ECM-7.0 CIIP weight calculation), etc.

As shown, flag “spatial_CIIP_flag” can be signaled first to indicate if a current block is coded with spatial CIIP. If not, flag “intraTMP_flag” can be signaled to indicate if the current block is using IntraTMP. In some embodiments, if an IntraTMP mode is used, flag “intraTMP fusion flag” can be signaled to indicate if the current block will use an IntraTMP fusion method to generate a prediction by fusing several IntraTMP matched blocks with weighting.

If the IntraTMP fusion method is used, a fused IntraTMP predictor will be generated. If the IntraTMP fusion method is not used, another flag “intraTMP_filtered_flag” can be signaled to indicate if a filtered IntraTMP prediction block will be used. In some embodiments, if the filtered IntraTMP method is used, the identified IntraTMP prediction block can be further filtered according to a derived filter. An index “intraTMP_idx” can be signaled to indicate which IntraTMP block will be used from an IntraTMP candidate list.

In some embodiments, another flag “intraTMP_fractional_pel_flag” can be signaled to indicate if a fractional-pel precision prediction block (e.g., half-pel, quarter-pel, or other suitable precision) will be used. If the fractional-pel precision is used, a fractional-pel index “intraTMP_fractional pel_idx” can be signaled to indicate a fractional-pel position.

### Example 3

In FIG. 2D, syntax 213 provides an example showing how a flag for IntraTMP (“intraTMP_flag”) can be signaled can be signaled. As show, flag “intraTMP_flag” can be signaled first to indicate if the current block is using IntraTMP.

If there is an IntraTMP mode, flag “intraTMP_fusion_flag” can be signaled to indicate that if a current block will use an IntraTMP fusion method to generate a prediction by fusing several IntraTMP matched blocks with weighting.

If the IntraTMP fusion method is used, a fused IntraTMP predictor can be generated. If IntraTMP fusion is not used, another flag “intraTMP_filtered_flag” can be signaled to indicate if a filtered IntraTMP prediction block will be used. In some embodiments, if the filtered IntraTMP method is used, the identified IntraTMP prediction block can be further filtered according to a derived filter. An index “intraTMP_idx” will be signaled to indicate which IntraTMP block will be used from an IntraTMP candidate list.

In some embodiments, flag “intraTMP_is_L_Shape_flag” can be signaled if an “L-shaped template” is used. If the “L-shaped” template is not used, another flag “intraTMP_is_left_or_above_template_flag” can be used to indicate if a left only template or an above-only template will be used. Embodiments of the “L-shape” template are discussed with reference to FIG. 2A.

Another flag “intraTMP_fractional_pel_flag” can be signaled to indicate if a fractional-pel precision prediction block (e.g., a half-pel, quarter-pel, or other suitable precision) is used. If fractional-pel is used, precision a fractional-pel index “intraTMP_fractional pel_idx” can be signaled to indicate a fractional-pel position.

FIG. 3 is a schematic diagram illustrating an intra prediction process in accordance with one or more implementations of the present disclosure. In the embodiments, an example search area for an intra-block copy (IBC) tool is illustrated. As shown, in the example of FIG. 3 the intra-block copy process may search a current CTU row 307 that has already been decoded, and an above CTU row 305. In the illustrated embodiment, for example, a predictor block 309 is indicated in the above CTU row 305. The predictor block 309 can be indicated by a block vector 311, which points from the top-left corner of the current CU 301 to the top-left corner of predictor block 309. Certain block vectors are not “legal” if they point to an area that is not available, such as an area that has not yet been decoded. For example, an illegal block vector 313 shown in FIG. 3 points at an area following the current CU 301 in decoding order.

In some embodiments, the block vector 311 can be signalled to indicate which block within the same picture will be copied to serve as a predictor for the current block. Signalling of the block vector 311 can be performed by signalling a block vector difference (BVD) in a bitstream, such that the block vector 311 can be determined by adding the BVD to a block vector predictor. In some embodiments, if a block vector from a previous CU is an exact match for a current block vector, it can be signalled by a merge flag.

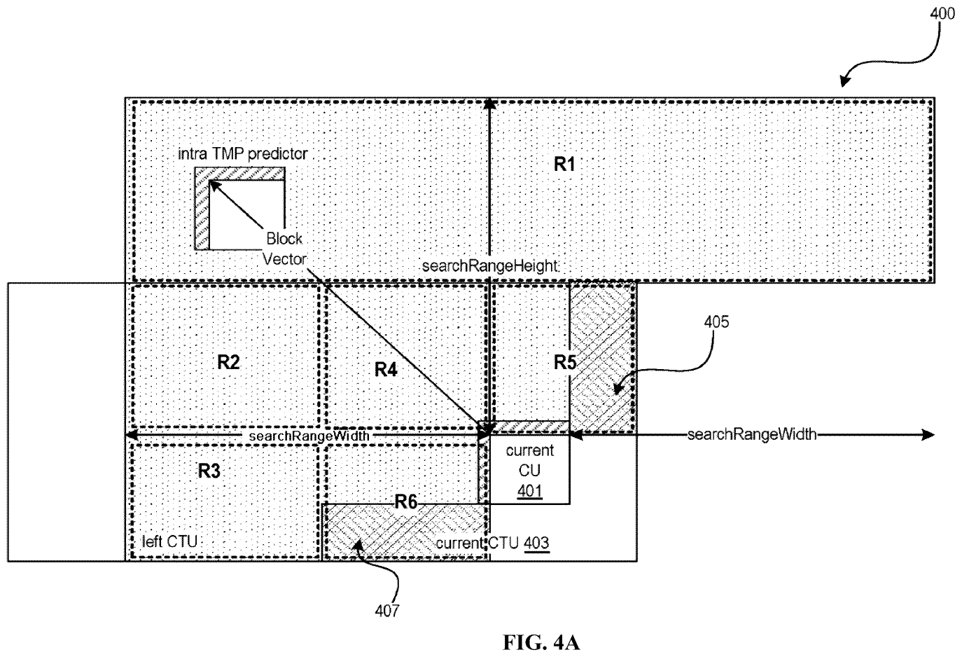

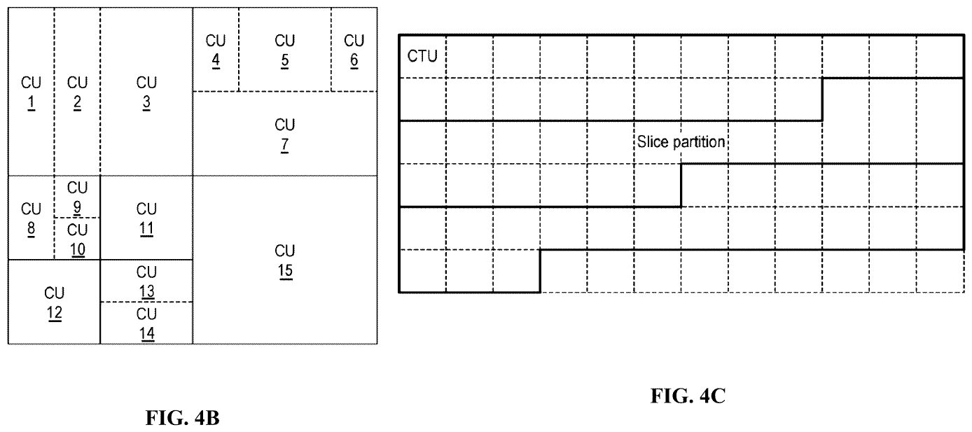

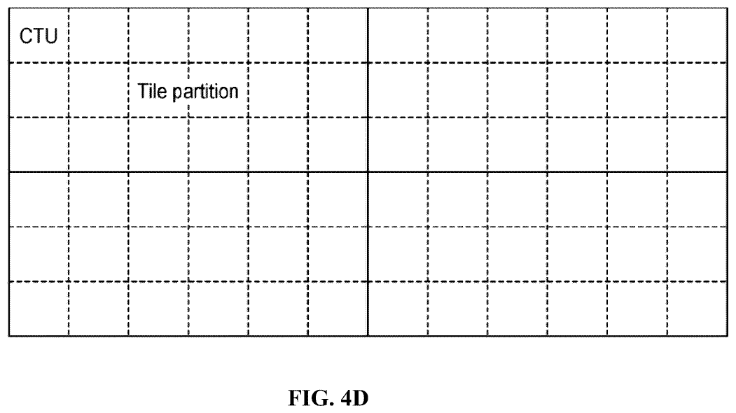

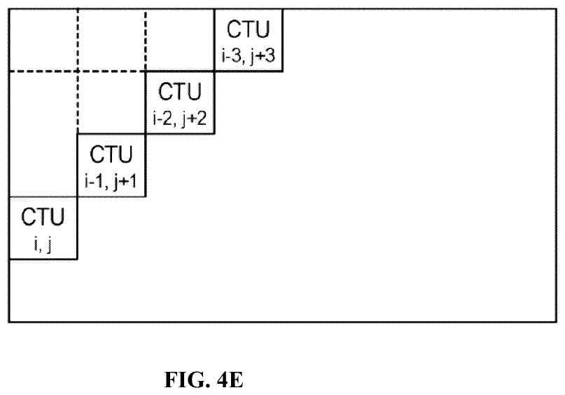

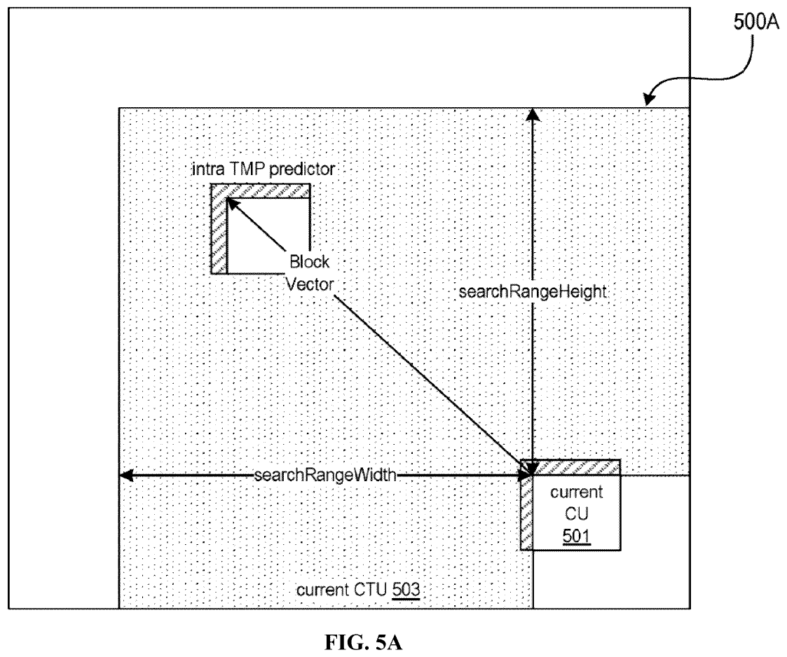

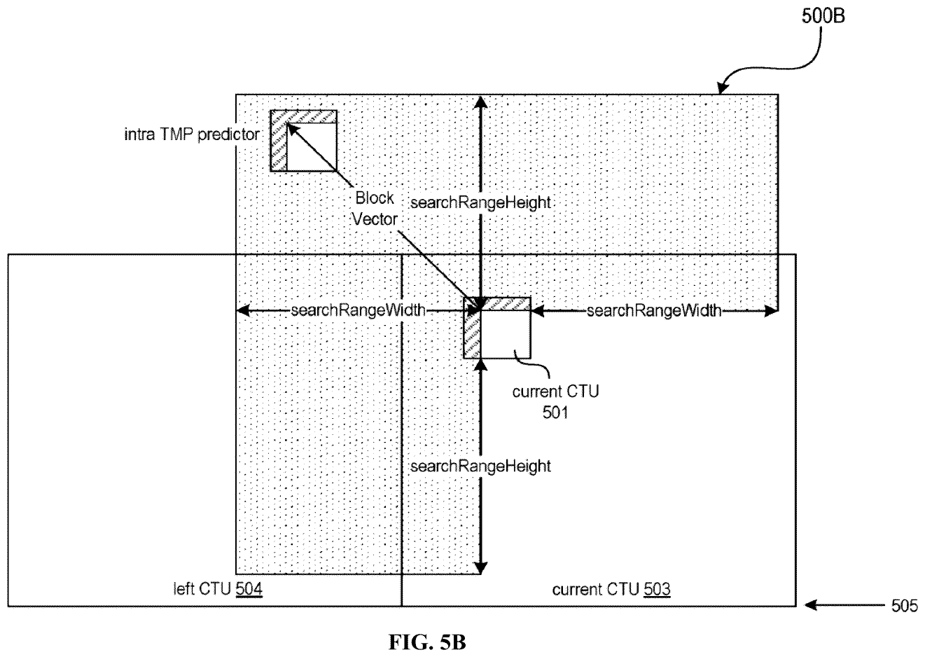

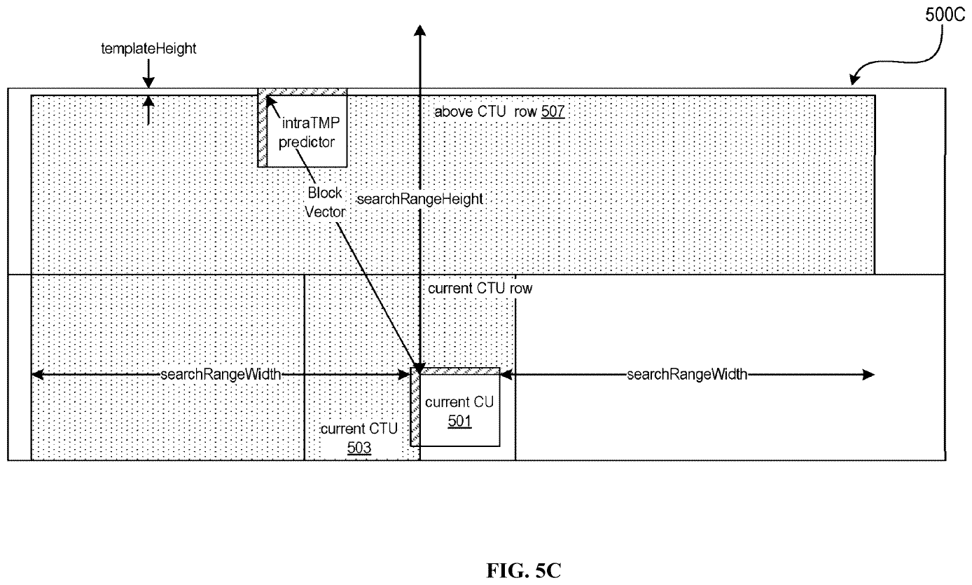

As shown, the block vector 311 points at a location within the same picture to indicate a block of samples equal in size to the current CU 301 that is used as a predictor block 309 for the current CU 301. In some embodiments, some restrictions can apply to the block vector 311. For example, the block vector 311 must point at a block of samples in the current picture that are available for intra prediction. As another example, the block vector can be restricted to a search region defined by a search tool (e.g., an intra-block copy (IBC) tool) which can be smaller than the current picture. For example, in VVC, the IBC search region is the current CTU and the previous CTU. In some embodiments, IBC search region can be the current CTU row and the above CTU row when the CTU size is 256×256, or the current CTU row and the above 2 CTU rows when the CTU size is 128×128 or smaller. In some embodiments, the present system can perform an IntraTMP process while additionally restricting the IntraTMP search area to the search area of an existing tool (such as the IBC tool) for alignment of buffering requirements. Various embodiments regarding search areas for IntraTMP processes are discussed in FIGS. 4A-5D.

FIG. 4A is a schematic diagram illustrating a search sequence of an IntraTMP process in a search area 400 in accordance with one or more implementations of the present disclosure. The search area 400 is determined by imposing a maximum length on IntraTMP block vectors, which as shown in FIG. 4A is a vector pointing from the top-left corner of the current CU to the top-left corner of the IntraTMP predictor. The maximum length of an IntraTMP block vector is (searchRangeWidth, searchRangeHeight), which is a maximum of searchRangeWidth horizontally and a maximum of searchRangeHeight vertically. The values of searchRangeWidth and searchRangeHeight are determined as a function of the current CU's width BlkW and height BlkH. For example, in one embodiment, they may be determined by following equations (A) and (B).

$$searchRangeWidth = max ( a * BlkW , min SearchRange ) \qquad ( A )$$

$$searchRangeHeight = max ( a * BlkH , min SearchRange ) \qquad ( B )$$

In equations (A) and (B), “max (x,y)” returns the maximum value between “x” and “y.”

In some embodiments, in Equations A and B, “a” can be set as “5” and “minSearchRange” can be set as “128.” In other embodiments, different values of “a” and “minSearchRange” may be used.

Let the top-left corner of the current CU be denoted by a coordinate position (currCuX, currCuY) within a coordinate system where (0, 0) refers to the top-left corner of the picture and increasing coordinate position horizontally and vertically indicates directions to the right and down respectively. Parameter “currCuX” refers to the horizontal position and currCuY refers to the vertical position. Then in this coordinate system the top-left corner of the search area 400 is located at (currCuX−searchRangeWidth, currCuY−searchRangeHeight). The top−right corner of the search area 400 is located at (currCuX+BlkW−1+searchRangeWidth, currCuY−searchRangeHeight). The bottom−left corner of the search area 400 may notionally be located at (currCuX−searchRange Width, currCuY+BlkH−1+searchRangeHeight).

In the example of FIG. 4A, the bottom-left corner is limited by the bottom boundary of the left CTU. The bottom-right corner of the search area 400 may notionally be located at (currCuX+BlkW−1+searchRangeWidth, currCuY+BlkH−1+searchRangeHeight). IntraTMP block vectors that point both to the right and down are not possible since they refer to areas of the picture that follow the current CU in coding order. The bottom-right boundary of the search area 400 is therefore complicated because it depends on the availability of samples. The shape of the search area under different conditions is described in further detail below with reference to FIGS. 4A, and 5A-5C.

Before limitations due to availability of samples, the search area 400 described above is a notional rectangle. In this disclosure, the search area 400 is defined such that the block of samples corresponding to any IntraTMP predictor must be fully contained within the search area 400. It may be understood that equivalent search areas can be defined according to the nature of the object(s) that must fit within the search area. For example, if the coordinate pointed to by an IntraTMP block vector must be fully contained within the search area, then a smaller but equivalent search area is defined with the top-left, top-right, bottom-left and bottom−right corners at (currCuX−searchRangeWidth, currCuY−searchRangeHeight), (currCuX+searchRangeWidth, currCuY−searchRangeHeight), (currCuX−searchRangeWidth, currCuY+searchRangeHeight), and (currCuX+searchRangeWidth, currCuY+searchRangeHeight) respectively.

In another example, if the block of samples corresponding to any IntraTMP predictor and its template must be fully contained within the search area, then a larger but equivalent search area is defined with the top−left, top−right, bottom−left and bottom−right corners at (currCuX−searchRangeWidth−templateWidth, currCuY−searchRangeHeight−templateHeight), (currCuX+BlkW−1+searchRangeWidth, currCuY−searchRangeHeight−templateHeight), (currCuX−searchRangeWidth−templateWidth, currCuY+BlkH−1+searchRangeHeight), and (currCuX+BlkW−1+searchRangeWidth, currCuY+BlkH−1+searchRangeHeight) respectively, where templateWidth and templateHeight refer to the dimensions of the template shape. It may be understood that variations in the definition of the search area do not affect the operation of the IntraTMP search algorithm described in this disclosure.

The search area 400 is further limited from the notional rectangle described above due to availability of samples. Availability of samples depends on two factors: firstly, whether the samples have already been reconstructed, and secondly, whether the samples belong to a logical unit that the current CU is permitted to use.

To determine whether samples have already been reconstructed we consider the partitioning structure of VVC. Each picture is divided into a tiling of square CTUs which are processed in raster scan order. When an intra prediction method is performed on a current CU in a current CTU, samples belonging to other CTUs preceding the current CTU in raster scan order are reconstructed and may be available for prediction. Samples belonging to CTUs following the current CTU in raster scan order are not reconstructed and therefore not available.

Each CTU itself is partitioned into CUs by a hierarchical structure consisting of quadtree, binary tree, and ternary tree splits, with an example of such splits shown in FIG. 4B. FIG. 4B is a schematic diagram illustrating an example partitioning of a CTU into CUs in accordance with one or more implementations of the present disclosure. The scan order of CUs within a CTU is determined by the partitioning structure. For a single level of partitioning split, the partitions are scanned in the following order:
[1] Left to right for the cases of horizontal binary tree split or horizontal ternary tree split.
[2] Top to bottom for the cases of vertical binary tree split or vertical ternary tree split.
[3] Top-left, top-right, bottom-left, bottom-right for the case of quadtree split.

If a partition contains further hierarchical splits, then all CUs within that partition are scanned before continuing to the CUs in the next partition. FIG. 4B shows an example partitioning of a CTU into 15 CUs, numbered from 1 to 15 to indicate their scan order. When an intra prediction method is performed on a current CU in a current CTU, samples belonging to other CUs in the current CTU which precede the current CU in the current CTU's partitioning scan order are reconstructed and may be available for prediction. Samples belonging to the current CU, or CUs following the current CU in the current CTU's partitioning scan order are not reconstructed and therefore not available.

Samples belonging to a CTU preceding the current CTU in raster scan order are considered reconstructed by the definition above. However, they are not necessarily available for intra prediction. To be considered available for prediction, they must also belong to a logical unit that the current CU is permitted to use. Pictures may be divided into sub-picture partitions, each of which contains a whole number of CTUs. FIG. 4C shows an example where the picture is divided into multiple slices. Samples belonging to a slice other than the slice containing the current CU are not available for intra prediction. Imposing this restriction allows slices to be decoded independently.

FIG. 4D is a schematic diagram illustrating tile partitioning in accordance with one or more implementations of the present disclosure. FIG. 4D shows an example where the picture is divided into multiple tiles. Samples belonging to a tile other than the tile containing the current CU are not available for intra prediction. Imposing this restriction allows tiles to be decoded independently.

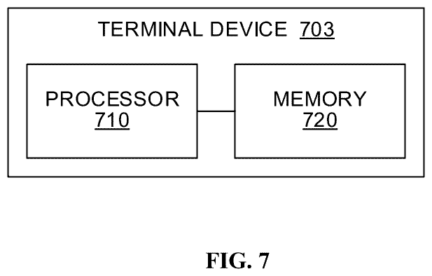

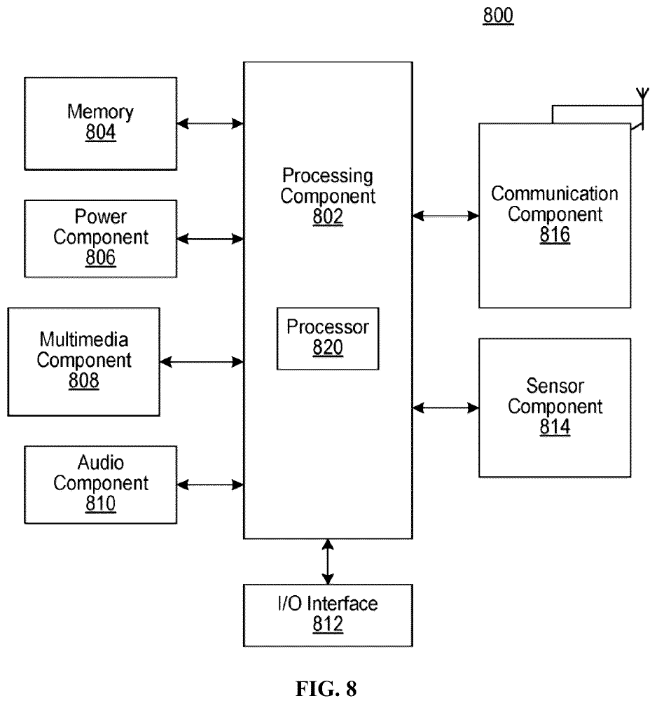

FIG. 4E shows an example where a picture is divided into wavefronts. Each wavefront corresponds to a row of CTUs, with dependency between the CTU rows reduced so that each wavefront can be decoded in parallel in a staggered fashion. In the example of FIG. 7, the wavefronts are processed with a delay of 1 CTU. Let us refer to the CTUs by their position in the grid, such that CTU_(i,j) indicates the CTU located at the i\hat{ }th CTU row and j\hat{ }th CTU column. Then when wavefront parallel processing is enabled by setting an SPS syntax element “sps_entropy_coding_sync_enabled_flag,” a CTU_(a,b) is not available if its CTU column position is greater than the current CTU_(i,j), i.e., if b>j.

How an intra prediction method deals with unavailability of reference samples needed for prediction varies depending on the method. The method may simply be disabled when such samples are not available. Alternatively, some extrapolation of the unavailable samples may be performed, such as by boundary extension.

Referring back to FIG. 4A, in the illustrated embodiments, the search area 400 is shaded and includes region R1 (e.g., an above CTU row region), region R2 (e.g., a first left CTU region), region R3 (e.g., a second left CTU region), region R4 (e.g., an upper left current CTU region), region R5 (e.g., a top-right current CTU region, including a top-right neighboring region, double hashed 405), and region R6 (e.g., a bottom-left current CTU region, including a bottom-left neighboring region 407, double hashed). The top-right region 405 and the bottom-left region 407 are described further below with reference to FIG. 4A. However, the specific areas within the top-right region 405 and the bottom-left region 407 included in the search area 400 are dependent on the CTU partitioning for the current CTU 403.

In the example of FIG. 4A, the top-right region 405 extends from the top-right corner of the current CU 401 to the top-right boundary of the current CTU 403. Following the coordinate system introduced above with reference to “searchRangeWidth” and “searchRangeHeight”, let the top-left corner of the current CTU 403 be denoted by a coordinate position (currCtuX, currCtuY) and let the CTU width and height be labelled as CtuW and CtuH respectively. Then in this coordinate system the top-left corner of the top-right region 405 is located at (currCuX+BlkW, currCtuY). The top-right corner of the top-right region 405 is located at (currCtuX+CtuW−1, currCtuY). The bottom-left corner of the top-right region 405 is located at (currCuX+BlkW, currCuY−1). The bottom-right corner of the top-right region 405 is located at (currCuX+CtuW−1, currCuY−1).

Similarly, in the example of FIG. 4A the top-left corner of the bottom-left region 407 is located at (currCtuX, currCuY+BlkH). The top-right corner of the bottom-left region 407 is located at (currCuX-1, currCuY+BlkH). The bottom-left corner of the bottom-left region 407 is located at (currCtuX, currCtuY+CtuH-1). The bottom-right corner of the bottom-left region 407 is located at (currCuX-1, currCtuY+CtuH-1).

In some embodiments, the top-right region 405 is included in the IntraTMP search region. Therefore, the IntraTMP process searches for a best candidate template among a plurality of candidate templates such that for one of the candidate templates, an associated candidate predictor has some part of its block of samples contained in the top-right region 405. Equivalently stated, at least one sample from the associated candidate predictor has a coordinate position (X, Y) where (X, Y) is within the current CTU, X is greater than or equal to currCuX+BlkW, and Y is less than or equal to currCuY−1.

In some embodiments, the bottom-left region 407 is included in the IntraTMP search region. Therefore, the IntraTMP process searches for a best candidate template among a plurality of candidate templates such that for one of the candidate templates, an associated candidate predictor has some part of its block of samples contained in the bottom-left region 407. Equivalently stated, at least one sample from the associated candidate predictor has a coordinate position (X, Y) where (X, Y) is within the current CTU, X is less than or equal to currCuX−1, and Y is greater than or equal to currCuY+BlkH.

In the example of FIG. 4A, the top-right region 405 and the bottom-left region 407 extend to the boundary of the current CTU 403 because the CTU boundary is more constrained than limitations imposed by “searchRangeWidth” and “searchRangeHeight”. FIGS. 5A and 5B show examples in which the limitations imposed by “searchRangeWidth” and “searchRangeHeight” constrain the search area 400 further than the CTU boundary.

In some embodiments, the search sequence can first search region R4, then region R5, region R6, region R1, region R2, and region R3. In some embodiments, the search sequence can be R4, R6, R5, R1, R2, and then R3. In some embodiments, the search sequence can be in any suitable combination of regions R1-R6.

In some embodiments, the boundary of the regions R1-R6 can be adjusted. For example, in some instances, region R4 and region R5 can be combined into one region. In some embodiments, region R4 and region R6 can be combined into one region. In some embodiments, region R4 can be expanded to include the left portion of region R5, and then region R5 can include only the top-right neighboring region 405 (double hashed). In some embodiments, region R4 can be expanded to include the upper portion of region R6, and then region R6 can include only the bottom-left neighboring region 407 (double hashed).

FIG. 5A-5C are schematic diagrams illustrating search areas of IntraTMP processes in accordance with one or more implementations of the present disclosure. In FIG. 5A, an example search region 500A (for a current CU 501) is configured as not beyond a maximum search range, defined by “searchRangeWidth” and “searchRangeHeight” as indicated. In some embodiments, the maximum search range results in a search region 500A with an upper boundary that is below the top boundary of a current CTU 503. Equivalently, in the coordinate system introduced in this disclosure, if (currCuY-searchRangeHeight) is greater than currCtuY, then the upper boundary of the search region 500A is located at (currCuY-searchRangeHeight). Equivalently, the upper boundary of the search region 500A is equal to max (currCtuY, (currCuY-searchRangeHeight)).

In some embodiments with reference to FIG. 5A, the maximum search range results in the search region 500A with a left boundary that is to the right of the left boundary of the current CTU 503. Equivalently, if (currCuX-searchRangeWidth) is greater than currCtuX, then the left boundary of the search region 500A is located at (currCuX-searchRangeWidth). Equivalently, the left boundary of the search region 500A is equal to max (currCtuX, (currCuX-searchRangeWidth)).

In FIG. 5B, an example search region 500B is configured as not beyond a maximum search range, defined by “searchRangeWidth” and “searchRangeHeight” as indicated. In some embodiments, the maximum search range results in a search region 500B with a lower boundary that is above the bottom boundary 505 of a current CTU 503 and a left CTU 504. Equivalently, if (currCuY+BlkH−1+searchRangeHeight) is less than (currCtuY+CtuH−1), then the lower boundary of the search region 500B is located at (currCuY+BlkH−1+searchRangeHeight). Equivalently, the lower boundary of the search region 500B is equal to min ((currCtuY+CtuH−1), (currCuY+BlkH−1+searchRangeHeight)). In the foregoing description, “min (x, y)” returns the minimum value between “x” and “y.”

In some embodiments with reference to FIG. 5B, the maximum search range results in a search region 500B with a right boundary that is to the left of the right boundary of the current CTU 503. Equivalently, if (currCuX+BlkW−1+searchRangeWidth) is less than (currCtuX+CtuW−1), then the right boundary of the search region 500B is located at (currCuX+BlkW−1+searchRangeWidth). Equivalently, the right boundary of the search region 500B is equal to min ((currCtuX+CtuW−1), (currCuX+BlkW−1+searchRangeWidth)).

In some embodiments, the limitations described with reference to FIGS. 4A, 5A, and 5B are combined. Then the top-right region 405 is limited to a block of samples with top-left corner located at (currCuX+BlkW, max (currCtuY, currCuY-searchRangeHeight)), top-right corner located at (min ((currCtuX+CtuW−1), (currCuX+BlkW−1+searchRangeWidth)), max (currCtuY, currCuY-searchRangeHeight)), bottom-left corner located at (currCuX+BlkW, currCuY−1), and bottom-right corner located at (min ((currCtuX+CtuW−1), (currCuX+BlkW−1+searchRangeWidth)), currCuY−1). The bottom-left region 407 is limited to a block of samples with top-left corner located at (max (currCtuX, (currCuX-searchRangeWidth)), currCuY+BlkH), top-right corner located at (currCuX−1, currCuY+BlkH), bottom-left corner located at (max (currCtuX, (currCuX-searchRangeWidth)), min ((currCtuY+CtuH−1), (currCuY+BlkH−1+searchRangeHeight))), and bottom-right corner located at (currCuX−1, min ((currCtuY+CtuH−1), (currCuY+BlkH−1+searchRangeHeight))).

In FIG. 5C, an example search region 500C is further limited to align with a search region available to an intra block copy (IBC) prediction tool. In some embodiments, if the top boundary of the IBC search region is lower than a maximum search range defined by “searchRangeHeight,” then the top boundary of the search region 500C is set to the top boundary of the IBC search region plus “templateHeight”. In some embodiments, the current CTU has a 256×256 size and the IBC search region is restricted vertically to the top boundary of an above CTU row. In some embodiments, the current CTU has a 128×128 size and the IBC search region is restricted vertically to the top boundary of two above CTU rows.

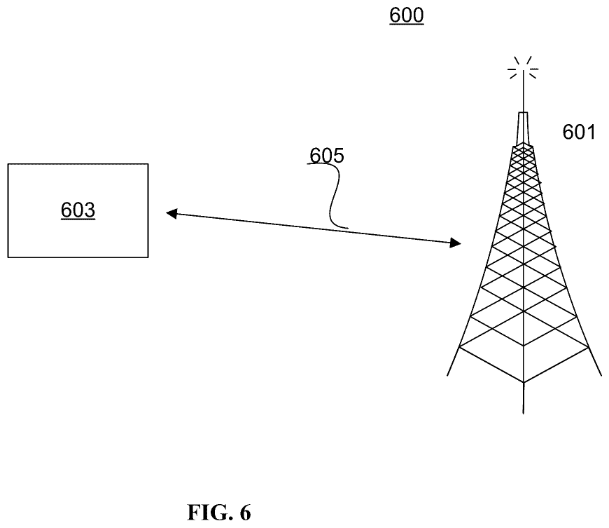

FIG. 6 is a schematic diagram of a wireless communication system 600 in accordance with one or more implementations of the present disclosure. The wireless communication system 600 can implement the framework discussed herein. As shown in FIG. 6, the wireless communications system 600 can include a network device (or base station) 601. Examples of the network device 601 include a base transceiver station (Base Transceiver Station, BTS), a NodeB (NodeB, NB), an evolved Node B (eNB or eNodeB), a Next Generation NodeB (gNB or gNode B), a Wireless Fidelity (Wi-Fi) access point (AP), etc. In some embodiments, the network device 601 can include a relay station, an access point, an in-vehicle device, a wearable device, and the like. The network device 601 can include wireless connection devices for communication networks such as: a Global System for Mobile Communications (GSM) network, a Code Division Multiple Access (CDMA) network, a Wideband CDMA (WCDMA) network, an LTE network, a cloud radio access network (Cloud Radio Access Network, CRAN), an Institute of Electrical and Electronics Engineers (IEEE) 802.11-based network (e.g., a Wi-Fi network), an Internet of Things (IOT) network, a device-to-device (D2D) network, a next-generation network (e.g., a 5G network), a future evolved public land mobile network (Public Land Mobile Network, PLMN), or the like. A 5G system or network can be referred to as a new radio (New Radio, NR) system or network.

In FIG. 6, the wireless communications system 600 also includes a terminal device 603. The terminal device 603 can be an end-user device configured to facilitate wireless communication. The terminal device 603 can be configured to wirelessly connect to the network device 601 (via, e.g., via a wireless channel 605) according to one or more corresponding communication protocols/standards. The terminal device 603 may be mobile or fixed. The terminal device 603 can be a user equipment (UE), an access terminal, a user unit, a user station, a mobile site, a mobile station, a remote station, a remote terminal, a mobile device, a user terminal, a terminal, a wireless communications device, a user agent, or a user apparatus. Examples of the terminal device 603 include a modem, a cellular phone, a smartphone, a cordless phone, a Session Initiation Protocol (SIP) phone, a wireless local loop (WLL) station, a personal digital assistant (PDA), a handheld device having a wireless communication function, a computing device or another processing device connected to a wireless modem, an in-vehicle device, a wearable device, an Internet-of-Things (IOT) device, a device used in a 5G network, a device used in a public land mobile network, or the like.

For illustrative purposes, FIG. 6 illustrates only one network device 601 and one terminal device 603 in the wireless communications system 600. However, in some instances, the wireless communications system 600 can include additional network device 601 and/or terminal device 603.

FIG. 7 is a schematic block diagram of a terminal device 703 (e.g., which can implement the methods discussed herein) in accordance with one or more implementations of the present disclosure. As shown, the terminal device 703 includes a processing unit 710 and a memory 720. The processing unit 710 can be configured to implement instructions that correspond to the methods discussed herein and/or other aspects of the implementations described above. It should be understood that the processor 710 in the implementations of this technology may be an integrated circuit chip and has a signal processing capability. During implementation, the steps in the foregoing method may be implemented by using an integrated logic circuit of hardware in the processor 710 or an instruction in the form of software. The processor 710 may be a general-purpose processor, a digital signal processor (DSP), an application specific integrated circuit (ASIC), a field programmable gate array (FPGA) or another programmable logic device, a discrete gate or transistor logic device, and a discrete hardware component. The methods, steps, and logic block diagrams disclosed in the implementations of this technology may be implemented or performed. The general-purpose processor 710 may be a microprocessor, or the processor 710 may be alternatively any conventional processor or the like. The steps in the methods disclosed with reference to the implementations of this technology may be directly performed or completed by a decoding processor implemented as hardware or performed or completed by using a combination of hardware and software modules in a decoding processor. The software module may be located at a random-access memory, a flash memory, a read-only memory, a programmable read-only memory or an electrically erasable programmable memory, a register, or another mature storage medium in this field. The storage medium is located at a memory 720, and the processor 710 reads information in the memory 720 and completes the steps in the foregoing methods in combination with the hardware thereof.

It may be understood that the memory 720 in the implementations of this technology may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM) or a flash memory. The volatile memory may be a random-access memory (RAM) and is used as an external cache. For exemplary rather than limitative description, many forms of RAMs can be used, and are, for example, a static random-access memory (SRAM), a dynamic random-access memory (DRAM), a synchronous dynamic random-access memory (SDRAM), a double data rate synchronous dynamic random-access memory (DDR SDRAM), an enhanced synchronous dynamic random-access memory (ESDRAM), a synchronous link dynamic random-access memory (SLDRAM), and a direct Rambus random-access memory (DR RAM). It should be noted that the memories in the systems and methods described herein are intended to include, but are not limited to, these memories and memories of any other suitable type. In some embodiments, the memory may be a non-transitory computer-readable storage medium that stores instructions capable of execution by a processor.

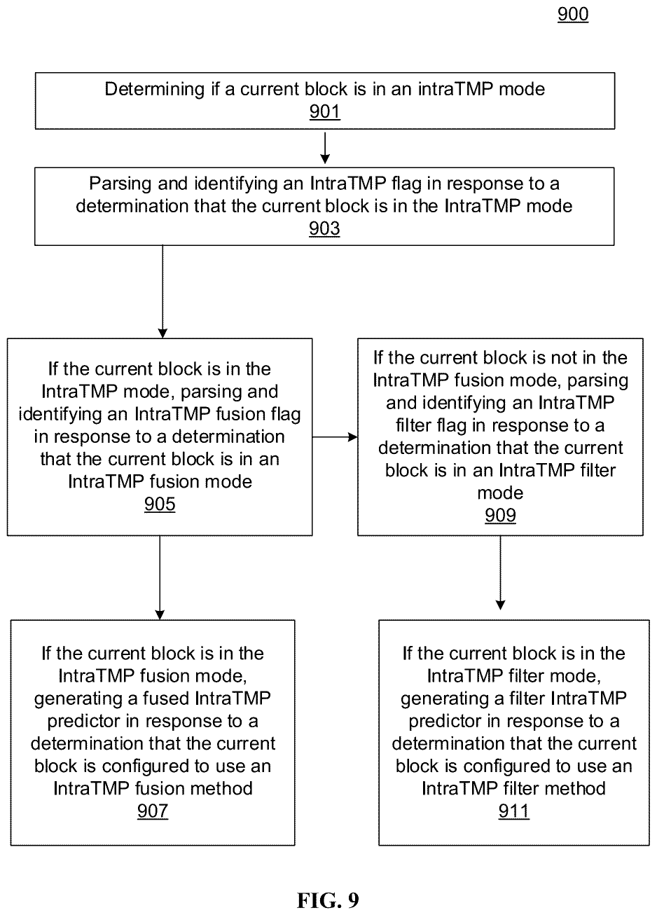

FIG. 8 is a schematic block diagram of an electronic device 800 in accordance with one or more implementations of the present disclosure. The electronic device 800 may include one or more following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device. Examples of such data include instructions for any application programs or methods operated on the electronic device, contact data, phonebook data, messages, pictures, video, etc. The memory 804 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 806 provides power for various components of the electronic device. The power component 806 may include a power management system, one or more power supplies, and other components associated with generation, management and distribution of power for the electronic device.

The multimedia component 808 may include a screen providing an output interface between the electronic device and a user. In some embodiments, the screen may include a Liquid Crystal Display (LCD) and a Touch Panel (TP). If the screen may include the TP, the screen may be implemented as a touch screen to receive an input signal from the user. The TP may include one or more touch sensors to sense touches, swipes and gestures on the TP. The touch sensors may not only sense a boundary of a touch or swipe action but also detect a duration and pressure associated with the touch or swipe action. In some embodiments, the multimedia component 808 may include a front camera and/or a rear camera. The front camera and/or the rear camera may receive external multimedia data when the electronic device is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 may include a Microphone (MIC), and the MIC is configured to receive an external audio signal when the electronic device is in the operation mode, such as a call mode, a recording mode and a voice recognition mode. The received audio signal may further be stored in the memory 804 or sent through the communication component 816. In some embodiments, the audio component 810 further may include a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 may include one or more sensors configured to provide status assessment in various aspects for the electronic device. For instance, the sensor component 814 may detect an on/off status of the electronic device and relative positioning of components, such as a display and small keyboard of the electronic device, and the sensor component 814 may further detect a change in a position of the electronic device or a component of the electronic device, presence or absence of contact between the user and the electronic device, orientation or acceleration/deceleration of the electronic device and a change in temperature of the electronic device. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device and other equipment. The electronic device may access a communication-standard-based wireless network, such as a WIFI network, a 2nd-Generation (2G) or 3G network or a combination thereof. In an exemplary embodiment, the communication component 816 receives a broadcast signal or broadcast associated information from an external broadcast management system through a broadcast channel. In an exemplary embodiment, the communication component 816 further may include a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a Bluetooth (BT) technology and another technology.

In an exemplary embodiment, the electronic device 810 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 804 including an instruction, and the instruction may be executed by the processing component 802 of the electronic device 800 to implement the methods discussed herein. For example, the non-transitory computer-readable storage medium may be a ROM, a Random Access Memory (RAM), a Compact Disc Read-Only Memory (CD-ROM), a magnetic tape, a floppy disc, an optical data storage device and the like.

FIG. 9 is a flowchart of a method in accordance with one or more implementations of the present disclosure. The method 900 can be implemented by a system or an apparatus (such as a system or an apparatus having an IntraTMP module discussed herein). The method 900 is for indicating an intra template matching prediction. The method 900 can includes, at block 901, determining if a current block is in an IntraTMP mode. Embodiments of IntraTMP module are discussed in detail with reference to FIGS. 1A-5C.

At block 903, the method 900 includes signaling (or parsing) an IntraTMP flag to identify in response to a determination that the current block is in the IntraTMP mode. At block 903, the method 900 continues by parsing and identifying an IntraTMP flag in response to a determination that the current block is in the IntraTMP mode. At block 905, the method 900 continues by, if the current block is in the IntraTMP mode, parsing and identifying an IntraTMP fusion flag in response to a determination that the current block is in an IntraTMP fusion mode. In some embodiments (for example, at an encoding side), the method 900 can include signaling a fusion flag. In some embodiments (for example, at a decoding side), the method 900 can include parsing a fusion flag.

At block 907, the method 900 continues by, if the current block is in the Intra TMP fusion mode, generating a fused IntraTMP predictor in response to a determination that the current block is configured to use an IntraTMP fusion method. At block 909, the method 900 continues by, if the current block is not in the IntraTMP fusion mode, parsing and identifying an IntraTMP filter flag in response to a determination that the current block is in an IntraTMP filter mode. At block 911, the method 900 continues by, if the current block is in the IntraTMP filter mode, generating a filter IntraTMP predictor in response to a determination that the current block is configured to use an IntraTMP filter method.

In some embodiments, the method 900 can include parsing and identifying an IntraTMP index to indicate a selected IntraTMP block from an IntraTMP candidate list. In some embodiments, the method 900 further comprises determining if the current block is configured to use a fractional-pel precision.

In some embodiments, the method 900 further comprises signaling (or parsing a bitstream to identify) a fractional-pel flag in response to a determination that the current block is configured to use the fractional-pel precision. In some embodiments, the method 900 further comprises signaling a fractional-pel index to indicate a fractional-pel position in response to a determination that the current block is configured to use the fractional-pel precision.

In some embodiments, the IntraTMP fusion method includes one or more of the following: a Decoder-side Intra Mode Derivation (DIMD) method; a Template-based Intra Mode Derivation (TIMD) method; and a planar mode and weight calculation method.

In some embodiments, the method 900 can comprise (i) determining if the current block is configured to use a specific-shaped template; and (ii) signaling (or parsing a bitstream to identify) a template shape flag to indicate that the specific-shaped template is used.

In some embodiments, the method 900 can comprise (1) determining if a current block is in a combined inter-intra prediction (CIIP) mode; (2) signaling (or parsing a bitstream to identify) a spatial CIIP flag in response to a determination that the current block is in the CIIP mode.

### Additional Considerations

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the described technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative implementations or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples; alternative implementations may employ differing values or ranges.

In the Detailed Description, numerous specific details are set forth to provide a thorough understanding of the presently described technology. In other implementations, the techniques introduced here can be practiced without these specific details. In other instances, well-known features, such as specific functions or routines, are not described in detail in order to avoid unnecessarily obscuring the present disclosure. References in this description to “an implementation/embodiment,” “one implementation/embodiment,” or the like mean that a particular feature, structure, material, or characteristic being described is included in at least one implementation of the described technology. Thus, the appearances of such phrases in this specification necessarily all refer to the same implementation/embodiment. On the other hand, such references are not necessarily mutually exclusive either. Furthermore, the particular features, structures, materials, or characteristics can be combined in any suitable manner in one or more implementations/embodiments. It is to be understood that the various implementations shown in the figures are merely illustrative representations and are not necessarily drawn to scale.

Several details describing structures or processes that are well-known and often associated with communications systems and subsystems, but that can unnecessarily obscure some significant aspects of the disclosed techniques, are not set forth herein for purposes of clarity. Moreover, although the following disclosure sets forth several implementations of different aspects of the present disclosure, several other implementations can have different configurations or different components than those described in this section. Accordingly, the disclosed techniques can have other implementations with additional elements or without several of the elements described below.

Many implementations or aspects of the technology described herein can take the form of computer- or processor-executable instructions, including routines executed by a programmable computer or processor. Those skilled in the relevant art will appreciate that the described techniques can be practiced on computer or processor systems other than those shown and described below. The techniques described herein can be implemented in a special-purpose computer or data processor that is specifically programmed, configured, or constructed to execute one or more of the computer-executable instructions described below. Accordingly, the terms “computer” and “processor” as generally used herein refer to any data processor. Information handled by these computers and processors can be presented at any suitable display medium. Instructions for executing computer- or processor-executable tasks can be stored in or on any suitable computer-readable medium, including hardware, firmware, or a combination of hardware and firmware. Instructions can be contained in any suitable memory device, including, for example, a flash drive and/or other suitable medium.

The term “and/or” in this specification is only an association relationship for describing the associated objects, and indicates that three relationships may exist, for example, A and/or B may indicate the following three cases: A exists separately, both A and B exist, and B exists separately.

These and other changes can be made to the disclosed technology in light of the above Detailed Description. While the Detailed Description describes certain examples of the disclosed technology, as well as the best mode contemplated, the disclosed technology can be practiced in many ways, no matter how detailed the above description appears in text. Details of the system may vary considerably in its specific implementation, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. Accordingly, the invention is not limited, except as by the appended claims. In general, the terms used in the following claims should not be construed to limit the disclosed technology to the specific examples disclosed in the specification, unless the above Detailed Description section explicitly defines such terms.

A person of ordinary skill in the art may be aware that, in combination with the examples described in the implementations disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

1. A method for indicating an intra template matching prediction (IntraTMP), comprising:
determining if a current block is in an IntraTMP mode;
parsing and identifying an IntraTMP flag in response to a determination that the current block is in the IntraTMP mode; and
parsing and identifying an IntraTMP index for indicating a selected IntraTMP block from an IntraTMP candidate list,
wherein the method further comprises:
in response to a determination that the current block is in the IntraTMP mode, parsing and identifying an IntraTMP fusion flag in response to a determination that the current block is in an IntraTMP fusion mode;
in response to a determination that the current block is in the IntraTMP fusion mode, generating a fused IntraTMP predictor in response to a determination that the current block is configured to use an IntraTMP fusion method;
in response to a determination that the current block is not in the IntraTMP fusion mode, parsing and identifying an IntraTMP filter flag in response to a determination that the current block is in an IntraTMP filter mode; and
in response to a determination that the current block is in the IntraTMP filter mode, generating a filter IntraTMP predictor in response to a determination that the current block is configured to use an IntraTMP filter method.

2. The method of claim 1, further comprising:
determining if the current block is configured to use a fractional-pel precision.

3. The method of claim 2, further comprising:
parsing and identifying a fractional-pel flag in response to a determination that the current block is configured to use the fractional-pel precision.

4. The method of claim 2, further comprising:
parsing and identifying a fractional-pel index to indicate a fractional-pel position in response to a determination that the current block is configured to use the fractional-pel precision.

5. The method of claim 1, wherein the IntraTMP fusion method includes a Decoder-side Intra Mode Derivation (DIMD) method.

6. The method of claim 1, wherein the IntraTMP fusion method includes a Template-based Intra Mode Derivation (TIMD) method.

7. The method of claim 1, wherein the IntraTMP fusion method includes a planar mode method.

8. The method of claim 1, wherein the IntraTMP fusion method includes a weight calculation method.

9. A method for indicating an intra template matching prediction (IntraTMP), comprising:
determining if a current block is in a combined inter-intra prediction (CIIP) mode;
parsing and identifying a spatial CIIP flag in response to a determination that the current block is in the CIIP mode;
parsing and identifying an IntraTMP flag in response to a determination that the current block is in the IntraTMP mode; and
parsing and identifying an IntraTMP index for indicating a selected IntraTMP block from an IntraTMP candidate list,
wherein the method further comprises:
in response to a determination that the current block is in the IntraTMP mode, parsing and identifying an IntraTMP fusion flag in response to a determination that the current block is in an IntraTMP fusion mode;
in response to a determination that the current block is in the IntraTMP fusion mode, generating a fused IntraTMP predictor in response to a determination that the current block is configured to use an IntraTMP fusion method;
in response to a determination that the current block is not in the IntraTMP fusion mode, parsing and identifying an IntraTMP filter flag in response to a determination that the current block is in an IntraTMP filter mode; and
in response to a determination that the current block is in the IntraTMP filter mode, generating a filter IntraTMP predictor in response to a determination that the current block is configured to use an IntraTMP filter method.

10. The method of claim 9, further comprising:
determining if the current block is configured to use a fractional-pel precision.

11. The method of claim 10, further comprising:
parsing and identifying a fractional-pel flag in response to a determination that the current block is configured to use the fractional-pel precision; or
parsing and identifying a fractional-pel index to indicate a fractional-pel position in response to a determination that the current block is configured to use the fractional-pel precision.

12. (canceled)

13. The method of claim 9, wherein the IntraTMP fusion method includes one or more of the following:
a Decoder-side Intra Mode Derivation (DIMD) method;
a Template-based Intra Mode Derivation (TIMD) method;
a planar mode method; or
a weight calculation method.

14-16. (canceled)

17. A method for indicating an intra template matching prediction (IntraTMP), comprising:
determining if a current block is in an IntraTMP mode;
parsing and identifying an IntraTMP flag in response to a determination that the current block is in the IntraTMP mode;
parsing and identifying a template shape flag for indicating that the specific-shaped template is used; and
determining if the current block is configured to use a specific-shaped template,
wherein the method further comprises:
in response to a determination that the current block is in the IntraTMP mode, parsing and identifying an IntraTMP fusion flag in response to a determination that the current block is in an IntraTMP fusion mode;
in response to a determination that the current block is in the IntraTMP fusion mode, generating a fused IntraTMP predictor in response to a determination that the current block is configured to use an IntraTMP fusion method; and
in response to a determination that the current block is not in the IntraTMP fusion mode, parsing and identifying an IntraTMP filter flag in response to a determination that the current block is in an IntraTMP filter mode; and
in response to a determination that the current block is in the IntraTMP filter mode, generating a filter IntraTMP predictor in response to a determination that the current block is configured to use an IntraTMP filter method.

18. The method of claim 17, further comprising:
parsing and identifying an IntraTMP index to indicate a selected IntraTMP block from an IntraTMP candidate list.

19. The method of claim 17, further comprising:
determining if the current block is configured to use a fractional-pel precision;
parsing and identifying a fractional-pel flag in response to a determination that the current block is configured to use the fractional-pel precision; and
parsing and identifying a fractional-pel index to indicate a fractional-pel position in response to a determination that the current block is configured to use the fractional-pel precision.

20. The method of claim 17, wherein the IntraTMP fusion method includes one or more of the following:
a Decoder-side Intra Mode Derivation (DIMD) method;
a Template-based Intra Mode Derivation (TIMD) method; and
a planar mode and weight calculation method.

21. A method for indicating an intra template matching prediction (IntraTMP), comprising:
determining if a current block is in an IntraTMP mode;
signaling an IntraTMP flag in response to a determination that the current block is in the IntraTMP mode; and
signaling an IntraTMP index to indicate a selected IntraTMP block from an IntraTMP candidate list,
wherein the method further comprises:
in response to a determination that the current block is in the IntraTMP mode, signaling an IntraTMP fusion flag in response to a determination that the current block is in an IntraTMP fusion mode;
in response to a determination that the current block is in the IntraTMP fusion mode, generating a fused IntraTMP predictor in response to a determination that the current block is configured to use an IntraTMP fusion method;
in response to a determination that the current block is not in the IntraTMP fusion mode, signaling an IntraTMP filter flag in response to a determination that the current block is in an IntraTMP filter mode; and
in response to a determination that the current block is in the IntraTMP filter mode, generating a filter IntraTMP predictor in response to a determination that the current block is configured to use an IntraTMP filter method.

22. The method of claim 21, further comprising:
determining if the current block is configured to use a fractional-pel precision.

23. The method of claim 22, further comprising:
signaling a fractional-pel flag in response to a determination that the current block is configured to use the fractional-pel precision.

24. The method of claim 22, further comprising:
signaling a fractional-pel index to indicate a fractional-pel position in response to a determination that the current block is configured to use the fractional-pel precision.

25-28. (canceled)
